(19) United States
(12) Patent Application Publication
(10) Pub. No.: US 2006/0248754 A1
(43) Pub. Date: Nov. 9, 2006

(54) Excavator stump shearing device

(76) Inventor: Gerald G. Martin, Dry Prong, LA (US)

Correspondence Address: John M. Harrison, 2139 E. Bert Kouns, Shreveport, LA, 71105, US

(21) Appl. No.: 11/374,778

(22) Filed: Mar. 14, 2006

Related U.S. Application Data
(60) Provisional application No. 60/678,777, filed on May 9, 2005.
(60) Provisional application No. 60/684,295, filed on May 26, 2005.

(51) Int. Cl. A01G 23/06

(52) U.S. Cl. 37/302

(57) ABSTRACT

An excavator stump shearing device which is characterized by a blade assembly carried by various mount devices for attachment to an excavator bucket or to an excavator boom or bucket arm. In a first preferred embodiment the blade assembly is fixed to a blade mount drum which is removably gripped by the bucket and thumb of an excavator bucket to position the blade elements of the blade assembly for shearing a stump. In other embodiments the blade assembly mount devices are characterized by mount blocks, various blade mount boxes, a bucket tooth and tooth mount assembly and a bucket-engaging pad apparatus. The blade elements of the blade assembly include a bevelled shearing blade and a companion transverse wedge or stinger blade for engaging, splitting and shearing a stump responsive to operation of the excavator boom or arm and in some embodiments, the excavator bucket. In a preferred embodiment the blade assembly is designed for removably mounting on the excavator bucket boom or arm using a blade assembly housing or mount box having pins that removably engage a pin coupler mounted on the excavator boom or arm.

### CROSS-REFERENCE TO RELATED APPLICATIONS

This application claims the benefit of and incorporates by reference prior filed copending U.S. Provisional Patent Applications Serial No. 60/678,777, Filed May 9, 2005 and Ser. No. 60/684,295, Filed May 26, 2005.

### SUMMARY OF THE INVENTION

An excavator stump shearing device which includes a blade assembly, including a blade backplate carrying a typically bevelled shearing blade and a wedge or stinger splitting blade extending transversely with respect to the blade backplate from one end of the horizontal shearing blade, for incrementally engaging, splitting and shearing a stump. The blade assembly is typically welded or otherwise attached to various coupling devices for mounting on an excavator bucket or bucket boom or arm. A first one of these devices includes a blade mount drum which is gripped by the conventional bucket and thumb assemblies of an excavator and the blade backplate element extends beneath the bucket bottom and optionally attaches, typically by means of a chain or chains, to the bucket to facilitate splitting and shearing of the stump by operation of the excavator bucket. Other blade mounting devices include a blade backplate fitted with blade blocks and corresponding spacer blocks for removably mounting the blade assembly on the excavator bucket at the bucket teeth. One or more connectors such as chains typically extend from the blade backplate to the excavator bucket for additional blade attachment security. In both of these embodiments the excavator and excavator bucket are operated in conventional manner to force the shearing blade and stinger or wedge blade into the stump at selected increments and cut the stump to ground level or below, in a quick, safe and efficient manner.

Another blade assembly coupling or mount element is characterized by a set of bucket teeth welded to the blade backplate and designed to removably engage corresponding bucket teeth mounts on the excavator bucket. Additional blade assembly mount devices or elements include various mount housings or boxes for mounting on the excavator bucket arm or boom.

In a preferred embodiment of the invention the blade assembly mount includes a blade mount box or housing fitted with oppositely-disposed pairs of openings and bosses for receiving mount pins and removably mounting the blade assembly directly to the bucket arm or boom and operating linkage of an excavator in place of the excavator bucket, typically using a pin coupler carried by the mount bucket linkage.

### BRIEF DESCRIPTION OF THE DRAWINGS

The invention will be better understood by reference to the accompanying drawings, wherein:

FIG. 1 is a front perspective view of a first embodiment of the excavator stump shearing device of this invention positioned in shearing configuration at a stump, more particularly illustrating a blade assembly welded to a blade mount drum which is located in the excavator bucket of an excavator and is releasably secured in place by operation of a bucket thumb mounted on the excavator bucket arm with the excavator bucket;

FIG. 2 is a right side elevation of the excavator stump shearing device illustrated in FIG. 1, with the bottom of the excavator bucket, one side of the blade mount drum and the blade backplate illustrated in section, more particularly illustrating a first preferred mounting of the blade mount drum on the blade assembly, and the blade assembly and blade mount drum on the excavator bucket;

FIG. 3 is a front perspective view of the excavator stump shearing device illustrated in FIG. 1, more particularly illustrating an open position of the excavator bucket thumb and a preferred removable seating of the blade assembly and the blade mount drum in place on the excavator bucket;

FIG. 4 is a front perspective view of the excavator stump shearing device illustrated in FIG. 3, more particularly illustrating the blade assembly and blade mount drum removed from contact with the excavator bucket and the excavator bucket thumb removed from the excavator bucket, for brevity;

FIG. 5 is a front perspective view of the excavator stump shearing device illustrated in FIG. 4, more particularly illustrating a typical blade assembly characterized by a tapered and bevelled shearing blade and a wedge or stinger splitting blade at one end of the shearing blade and a preferred technique for securing the blade mount drum on the blade backplate element of the blade assembly;

FIG. 6 is a rear perspective view of the excavator stump shearing device blade assembly illustrated in FIG. 5, further illustrating the preferred welding of the blade mount drum on the blade backplate element of the blade assembly using spaced-apart rear block mounts;

FIG. 7 is a front perspective view of a second embodiment of the excavator stump shearing device of this invention, more particularly illustrating backplate mount blocks welded to corresponding block mounts extending from typically welded attachment to the blade backplate and corresponding spacer blocks situated beneath the extending ends of each of the backplate mount blocks and typically secured in place by means of block bolts, for removably seating the blade assembly on the excavator bucket at the bucket teeth;

FIG. 8 is a rear and bottom perspective view of the excavator stump shearing device and excavator bucket illustrated in FIG. 7, more particularly illustrating a preferred chain and chain tightener apparatus for removably mounting the second embodiment blade assembly on the excavator bucket;

FIG. 9 is a front perspective view of the excavator stump shearing device illustrated in FIG. 7 removed from the excavator bucket and more particularly illustrating the backplate mount blocks and corresponding threaded block bolt openings for receiving the respective block bolts illustrated in FIG. 7;

FIG. 10 is a rear perspective view of the excavator stump shearing device illustrated in FIG. 9, more particularly illustrating the backplate mount blocks and corresponding block bolts threaded through the block bolt openings illustrated in FIG. 7 and engaging corresponding spacer blocks for removably seating the second embodiment blade assembly on the excavator bucket;

FIG. 11 is a front perspective view of a third embodiment of the excavator stump shearing device of this invention, illustrating a first blade mount box element of the blade assembly receiving the blade assembly and positioned on the excavator bucket arm or boom and operating linkage, in place of the excavator bucket;

FIG. 12 is a reverse front perspective view of the third embodiment blade assembly and blade mount box illustrated in FIG. 11, detached from the excavator bucket arm and operating linkage;

FIG. 13 is a rear perspective view of the blade assembly and blade mount box embodiment illustrated in FIG. 12.

FIG. 14 is a perspective view of another embodiment of the excavator stump shearing device, wherein the blade assembly is fitted with spaced-apart bucket teeth that removably engage corresponding bucket teeth mounts on the excavator bucket, for removably assembling the blade assembly on the excavator bucket;

FIG. 15 is an exploded view of the blade assembly and bucket teeth mount configuration illustrated in FIG. 14;

FIG. 16 is a perspective view of yet another embodiment of the invention, wherein the blade assembly extends from a blade assembly housing or box fitted with spaced-apart top pin-engaging slots for receiving corresponding pins provided on the excavator bucket arm and bucket operating linkage of the excavator;

FIG. 17 is an exploded view of the blade assembly housing or box and the connected blade assembly illustrated in FIG. 16;

FIG. 18 is a perspective view of still another embodiment of the invention, wherein a bucket-engaging pad is attached to the blade assembly and extends into an excavator bucket and mounts therein using a wedge and bolt apparatus for removably mounting the blade assembly and bucket-engaging pad on the excavator bucket;

FIG. 19 is an exploded view of the bucket-engaging pad apparatus and blade assembly illustrated in FIG. 18;

FIG. 20 is a longitudinal sectional view of the bucket-engaging pad illustrated in FIGS. 18 and 19, more particularly illustrating a pad wedge and articulating bolt arrangement for securing the bucket engaging pad and blade assembly in place on the excavator bucket;

FIG. 21 is a perspective view of still another embodiment of the invention, wherein the blade assembly is elongated and extends from a parallel mount plate housing or box fitted with parallel mount plates that have oppositely-disposed and spaced-apart side panel openings and bosses for receiving the respective arm mount pins on the excavator bucket boom or arm and the excavator arm linkage and removably securing the parallel mount plate housing and elongated blade assembly to the excavator arm;

FIG. 22 is a perspective view of the parallel mount plate housing or box illustrated in FIG. 21, more particularly illustrating connection of the arm mount pins to a pin coupler carried by the boom arm of an excavator;

FIG. 23 is a perspective view of a typical conventional pin coupler illustrated in FIG. 22 for removably engaging the respective arm mount pins provided on the parallel mount plate housing or box and removably securing the parallel mount plate housing or box and the blade assembly to the excavator arm; and

FIG. 24 is a longitudinal sectional view of the conventional pin coupling illustrated in FIG. 23, more particularly illustrating the pin-engaging trigger mechanism.

### DESCRIPTION OF THE PREFERRED EMBODIMENTS

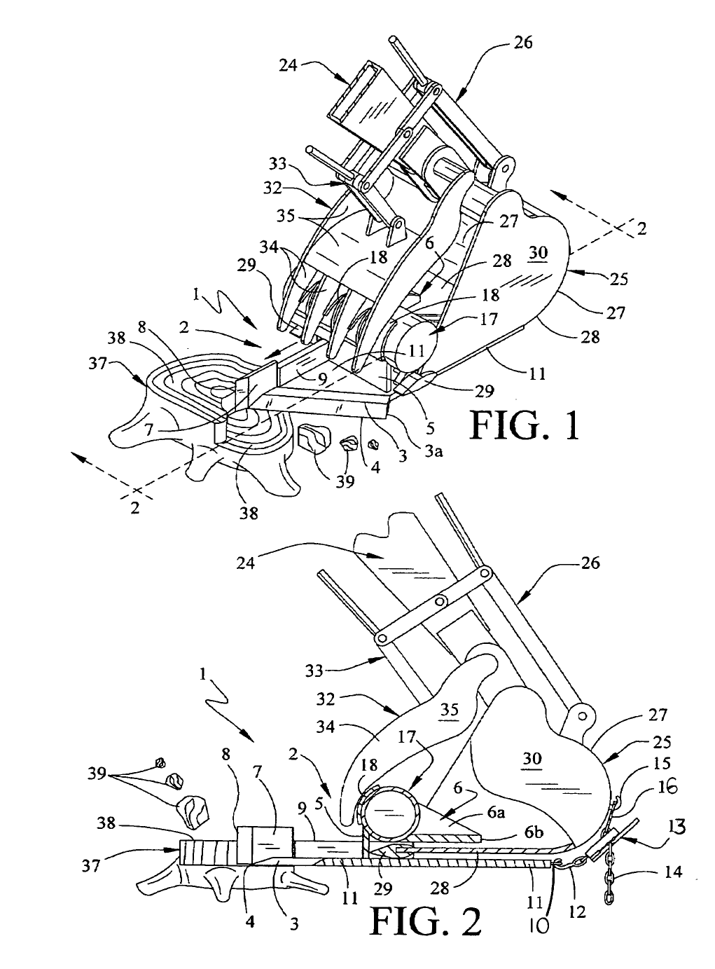

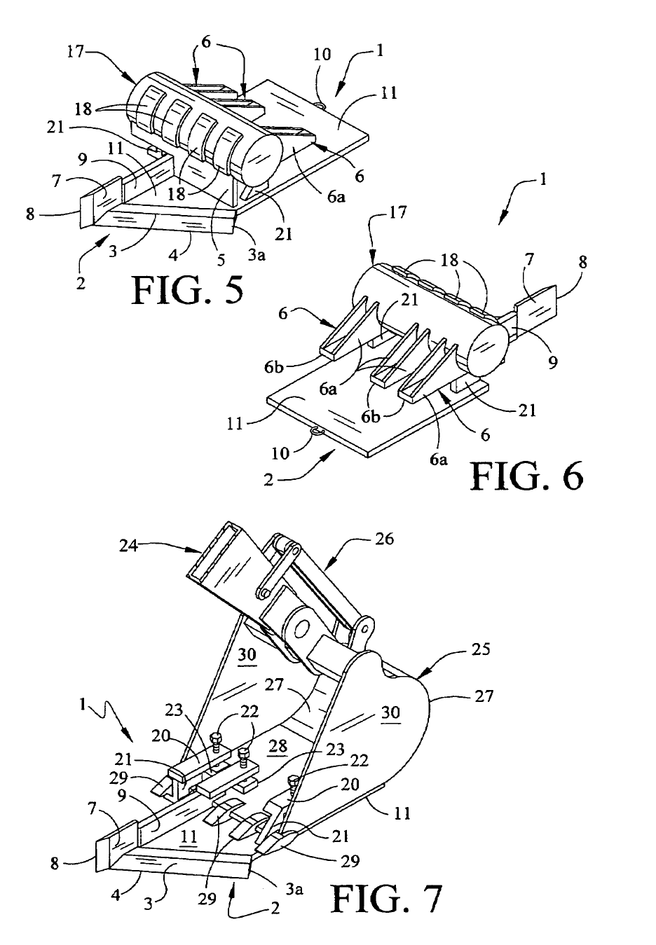

Referring initially to FIGS. 1-6 of the drawings, in a first embodiment the excavator stump shearing device of this invention is generally illustrated by reference numeral 1. The excavator stump shearing device 1 includes a blade assembly 2 which is characterized by a shearing blade 3, typically having a tapered and bevelled shearing blade edge 4 and further typically welded to the front end of a correspondingly tapered, flat blade backplate 11. A front blade mount 5 is typically positioned rearwardly of the shearing blade 3 and is also typically welded to the blade backplate 11 for purposes which will be hereinafter further described. A splitting wedge or stinger blade 7 extends upwardly from typically welded attachment to the blade backplate 11 and to one end of the shearing blade 3, typically transverse to the plane of the shearing blade 3 and blade backplate 11, and typically at the maximum length dimension of the shearing blade 3. The wedge or stinger blade 7 includes a bevelled, sharp stinger blade edge 8 extending forwardly from the apex of the shearing blade 3, as illustrated in FIG. 1. A stinger blade mount 9 extends upwardly from typically welded attachment to the blade backplate 11 in alignment with and typically welded to the wedge or stinger blade 7 and the front blade mount 5 for supporting and strengthening the wedge or stinger blade 7 during operation of the blade assembly 2. In a most preferred aspect of the invention the wedge or stinger blade 7 is aligned on the blade backplate 11 with the vertical plane of the excavator bucket arm 24 and bucket operating linkage 26 of an excavator bucket 25, for purposes which will be hereinafter described. Furthermore, the blade edge or end 3a of the shearing blade 3 which is opposite the wedge or stinger blade 7, is preferably extended beyond the plane of the bucket side 30 of the excavator bucket 25 and the edge of the blade backplate 11 (FIG. 1) to facilitate use of the excavator stump-shearing device in close proximity to trees near the stump 37 to be removed.

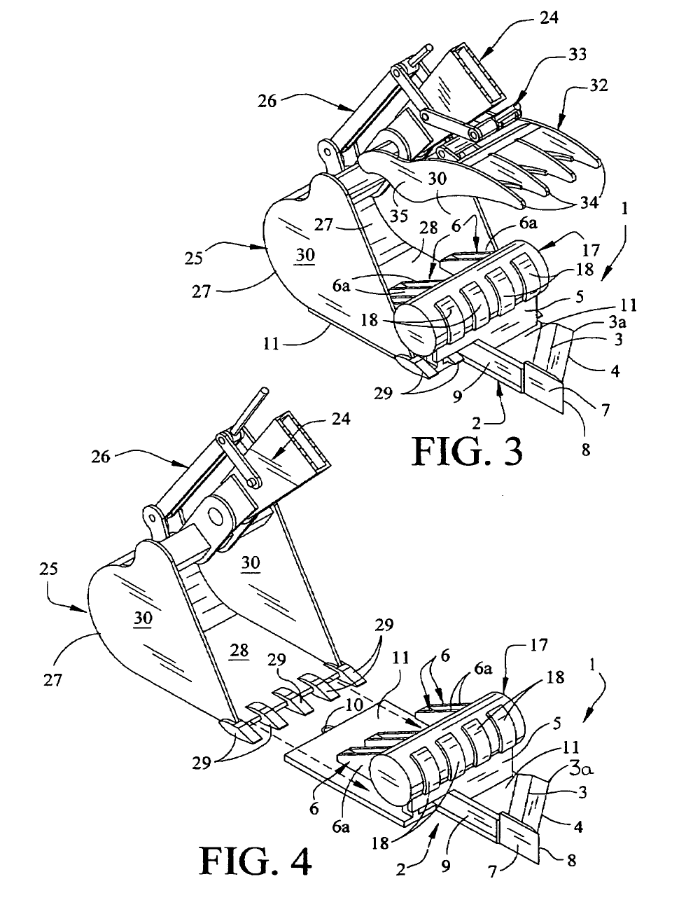

As further illustrated in FIGS. 1-6 of the drawings, the blade backplate 11 extends from a position at the shearing blade 3 and wedge or stinger blade 7, rearwardly beneath the bucket bottom 28 of the excavator bucket 25, having bucket sides 30, to the bucket heel 27 of the excavator bucket 25. Furthermore, the bucket teeth 29, which are spaced-apart on the front edge of the bucket bottom 28 of the excavator bucket 25 in conventional fashion, are designed to slide beneath the mount base 6b of three, spaced-apart rear blade mounts 6 (FIGS. 3, 4 and 6), each having a parallel pair of mount webs 6a extending upwardly from a corresponding mount base 6b (FIG. 6), for welded attachment to the blade mount drum 17. The blade mount drum 17 is, in turn, typically welded to the upward-standing front blade mount 5, which engages and limits the forward travel of the bucket teeth 29 (FIG. 2) and is preferably equipped with curved drum pads 18 which are spaced-apart and typically welded to the blade mount drum 17. The drum pads 18 receive the corresponding spaced-apart thumb teeth 34 of a bucket thumb 32, which is connected to the excavator bucket arm 24 at a thumb base 35 by means of a thumb linkage 33, typically in conventional fashion. In similar manner, the excavator bucket 25 is conventionally attached to the excavator bucket arm 24 and the bucket operating linkage 26, as further illustrated in FIGS. 1 and 2 of the drawings. Accordingly, as illustrated in FIG. 3 of the drawings, the bucket thumb 32 is initially rotated upwardly into an open configuration by operation of a connected conventional excavator (not illustrated) to manipulate the thumb linkage 33 to the disengaged position illustrated in FIG. 3. The excavator bucket 25 can then be operated by means of the bucket operating linkage 26 to slide the bucket teeth 29 beneath the corresponding rear blade mounts 6, which are welded to and spaced apart from the blade backplate 11 by means of block mounts 21 (FIG. 6). This action slides the rear portion of the blade backplate 11 beneath the bucket bottom 28 of the excavator bucket 25 and removably secures the blade assembly 2 to the excavator bucket 25, as illustrated in FIGS. 2 and 3. The bucket thumb 32 is then rotated downwardly into closed configuration by hydraulic action in conventional manner by operation of the excavator (not illustrated) using the thumb linkage 33, to engage the thumb teeth 34 with the corresponding drum pads 18 on the blade mount drum 17 and further secure the blade assembly 2 on the excavator bucket 25, as illustrated in FIGS. 1 and 2 of the drawings. Additional security can be provided in mounting the blade assembly 2 to the excavator bucket 25 by using a chain tightener 13 (FIG. 2). A backplate hook 10 is secured to the blade backplate 11 in any convenient fashion and connects a backplate mount hook 12 and backplate mount chain 14 to a hook 16 and a bucket bracket 15, provided on the bucket heel 27 of the excavator bucket 25. Operation of the chain tightener 13 tensions the backplate mount chain 14 and further secures the blade assembly 2.

Referring again to FIGS. 1 and 2 of the drawings, when the excavator stump-shearing device 1 is in use, the excavator is first operated to maneuver the excavator bucket 25 in close proximity to the stump 37, with the blade assembly 2 positioned at the base of the stump 37, as illustrated. The excavator is then operated to move the excavator bucket 25 in the direction indicated by the arrows in FIGS. 1 and 2, to shear and split or wedge-cut a segment of the stump 37 at the cut surface 38 and remove the resulting wood chips 39. As the blade assembly 2 cuts through the stump 37, the angled or tapered shearing blade edge 4 horizontally cuts the wood chips 39 at the cut surface 38, while the wedge or stinger blade 7 acts as a wedge to split the stump 37 vertically and isolate that portion of the wood chips 39 of selected size which are simultaneously sheared at the cut surface 38, as further illustrated in FIG. 1. Since the wedge or stinger blade 7 is in substantially the same vertical plane as the excavator bucket arm 24 and the bucket operating linkage 26 of the excavator bucket 25, the pulling forces operating on the excavator bucket 25 also operate in an optimum manner on the wedge or stinger blade 7 and the companion shearing blade 3 to shear the stump 37, without applying a damaging torque to the excavator bucket 25 and/or the bucket-operating linkage 26.

In another embodiment of the invention the blade assembly 2 is illustrated in FIGS. 7-10 of the drawings. The blade assembly 2 in this embodiment includes a shearing blade 3 and a wedge or stinger blade 7 mounted on the blade backplate 11 by means of the block mounts 21, as described above. Further included are elevated backplate mount blocks 20, (FIG. 9), shaped with, welded on, or otherwise attached to the block mounts 21, for receiving the respective bucket teeth 29 of the excavator bucket 25 therebetween. In a preferred aspect of this embodiment of the invention each of the backplate mount blocks 20 is fitted with a threaded block bolt opening 22a, as further illustrated in FIG. 9, for receiving corresponding block bolts 22, as illustrated in FIGS. 7 and 10 of the drawings. Spacer blocks 23 are situated beneath each of the block bolts 22 and the respective backplate mount blocks 20 for receiving the free ends of the block bolts 22, respectively. The block bolts 22 can then be tightened in the corresponding backplate mount blocks 20 against the corresponding spacer blocks 23 to strengthen the backplate mount blocks 20 and secure the blade assembly 2 on the excavator bucket 25 in a friction-fit when the blade assembly 2 is inserted on the excavator bucket 25 at the bucket teeth 29, as illustrated in FIG. 7 of the drawings.

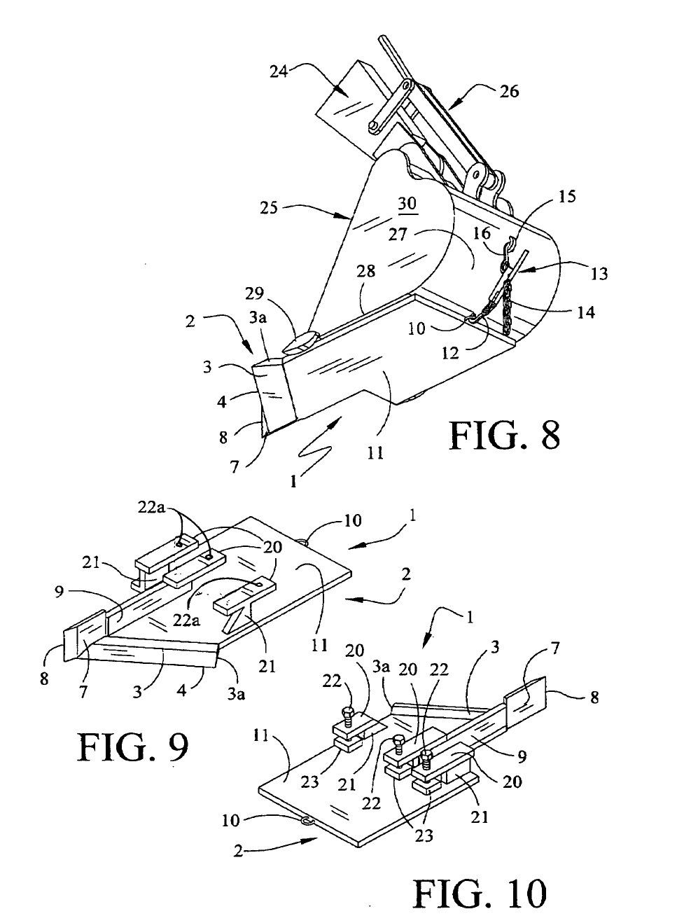

Referring now to FIG. 8 of the drawings in another preferred aspect of this embodiment of the invention a backplate hook 10 is welded or otherwise fixed to or near the rear end of the blade backplate 11 and is designed to removably receive a backplate mount hook 12, attached to one end of a conventional chain tightener 13. A backplate mount chain 14 is positioned to engage the chain tightener 13 and the opposite end of the backplate mount chain 14 is fitted with another hook 16 which is secured to a bucket bracket 15, that is welded or otherwise attached to the bucket heel 27 of the excavator bucket 25. Accordingly, it will be appreciated from a consideration of FIG. 8 of the drawings that tightening of the backplate mount chain 14 utilizing the chain tightener 13 in conventional fashion, secures the blade backplate 11 against the bucket bottom 28 of the excavator bucket 25 and thus mounts the blade assembly 2 on the excavator bucket 25. It will be further appreciated by those skilled in the art that one or more of the backplate mount chain 14 and the chain tightener 13 combinations can be used with a corresponding pair of the backplate hooks 10 and the bucket bracket 15 to further secure the blade assembly 2 on the excavator bucket 25, as deemed desirable.

Accordingly, it will be appreciated from a consideration of FIGS. 7-10 of the drawings that the blade assembly 2 in this embodiment of the invention can be quickly and easily mounted on the excavator bucket 25 by initially reverse-operating the block bolts 22 in the backplate mount blocks 20 and aligning the bucket teeth 29 with corresponding openings between the respective sets of backplate mount blocks 20 and block mounts 21. The excavator (not illustrated) and the excavator bucket 25 are then operated to slide the rear end of the blade backplate 11 beneath and against the bucket bottom 28 to the bucket heel 27, and the top surface of the bucket bottom 28 beneath the backplate mount blocks 20, as illustrated in FIGS. 7 and 8. The spacer blocks 23 are then positioned beneath the respective block bolts 22 and the block bolts 22 tightened against the spacer blocks 22. The backplate mount chain or chains 14 and chain tightener(s) 13 can then be extended from the corresponding back plate hook or hooks 10 to the bucket bracket 15 utilizing the backplate mount hook(s) 12 and the hook(s) 16, respectively, as described above. The backplate chain tightener or tighteners 13 are then manipulated to tighten the backplate mount chain or chains 14 and removably secure the blade assembly 2 tightly on the excavator bucket 25.

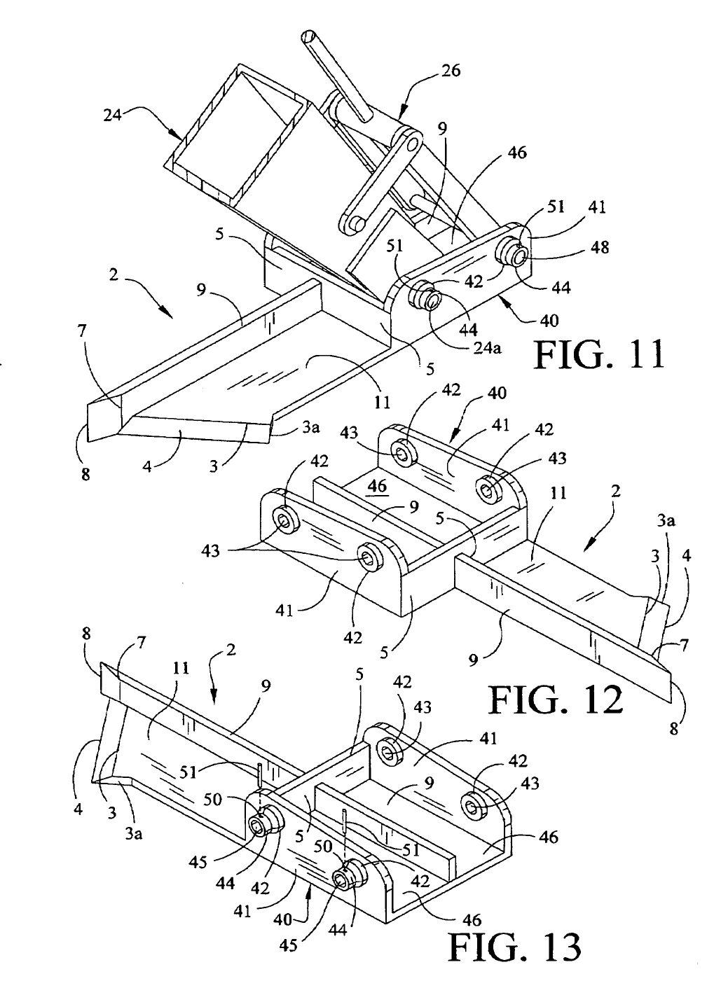

In a third embodiment of the invention the excavator stump shearing device 1 is characterized by a blade assembly 2 mounted on a blade mount box 40, having parallel side panels 41 that span and join the front blade mount 5, which is typically welded to the side panels 41 and the blade backplate 11, as illustrated in FIGS. 11-13 of the drawings. A pair of spaced-apart side panel bosses 42 are provided in each of the side panels 41 in opposed and aligned sets and each include a boss opening 43. Two of the boss openings 43 communicate with corresponding boss nipple openings 45, provided in a pair of boss nipples 44 that extend from a pair of the side panel bosses 42 in a selected one of the side panels 41, as further illustrated in FIG. 13. It is understood that the boss nipples 44 may be located on the opposite one of the side panels 41 from the position illustrated in FIGS. 11 and 13, as desired. The bottom panel 46 of the blade mount box 40 is typically an extension of the blade backplate 11 and typically can be fabricated in one piece with the blade backplate 11. As in the case of the first two embodiments illustrated in FIGS. 1-10 of the drawings, the shearing blade 3 in the blade assembly 2 is characterized by a bevelled shearing blade edge 4 shaped in the front edge of the blade backplate 11. A stinger blade mount 9 extends forwardly from typically welded attachment to the bottom panel 46 and the front blade mount 5 and terminates to define a wedge or stinger blade 7, having a stinger blade edge 8, as illustrated. The stinger blade mount 9 is typically extended through and welded in a notch provided in the front blade mount 5 and is also typically welded across the top of the bottom panel 46, as indicated in FIGS. 12 and 13 of the drawings for strengthening the blade mount box 40 and the entire blade assembly 2.

Referring now to FIGS. 11 and 13 of the drawings, the blade box 40 carrying the blade assembly 2 is designed for removable attachment to the excavator bucket arm 24 and the bucket operating linkage 26 by means of an arm mount pin 24a, that fits in opposed ones of the boss openings 43 of the side panel bosses 42 and the front boss nipple opening 45 in a boss nipple 44. Similarly, a front linkage pin 48 seats in oppositely-disposed ones of the front boss nipple openings 45 and boss openings 43. The arm mount pins 24a and the front linkage pins 48 are typically secured in position on the blade mount box 40 by keeper pins 51 that extend through corresponding transverse keeper pin openings 50 provided in the two spaced-apart boss nipples 44 (FIG. 13) to maintain the excavator bucket arm 24 and the bucket operating linkage 26 in the functional configuration illustrated in FIG. 11 of the drawings. Accordingly, removal of the blade assembly 2 and the blade mount box 40 combination from attachment to the excavator bucket arm 24 and the bucket operating linkage 26 is effected by initially removing the respective keeper pins 51 (typically roll pins) from the corresponding keeper pin openings 50 and then removing the arm mount pins 24a and the front linkage pins 48 from the corresponding boss openings 43 and boss nipple openings 45, respectively, as well as from respective aligned openings (not illustrated) in the excavator bucket arm 24 and bucket operating linkage 26.

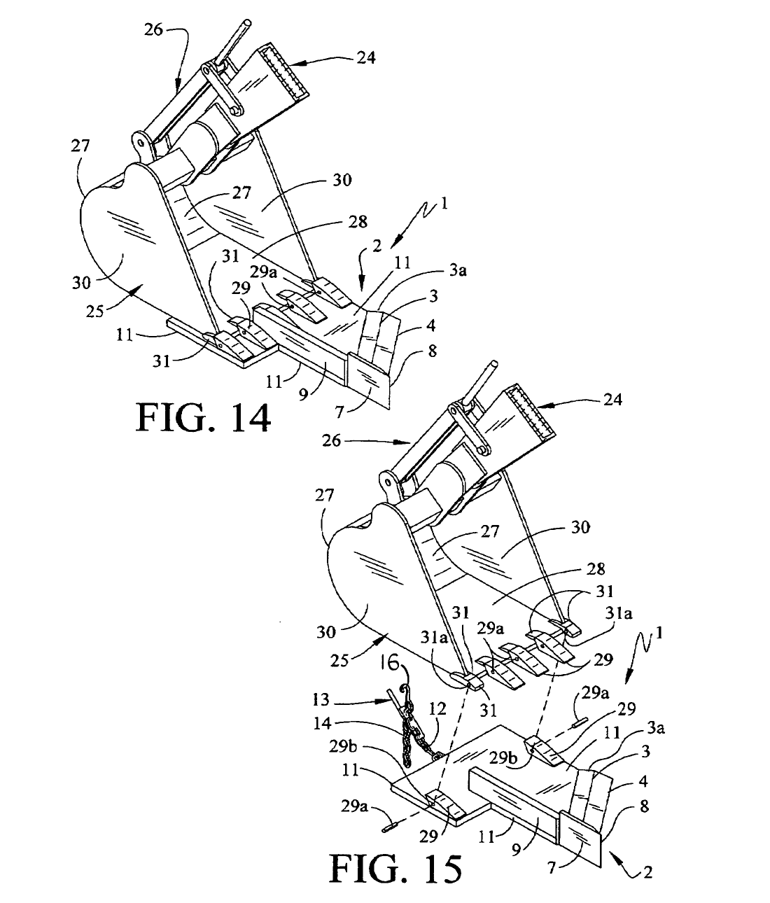

Referring now to FIGS. 14 and 15 of the drawings, in another embodiment of the invention the blade assembly 2 is configured substantially as illustrated in FIGS. 1-13 and is fitted with a pair of bucket teeth 29, each having pin openings 29b for receiving tooth pins 29a as illustrated in FIG. 15. The bucket teeth 29 are typically welded to the blade backplate 11 in spaced-apart relationship and are designed to engage and receive corresponding bucket tooth mounts 31, which are welded or otherwise attached to the bucket bottom 28 of the excavator bucket 25. The tooth pins 29a are inserted through the pin openings 29b and corresponding tooth mount openings 31 a in the bucket tooth mounts 31, to removably secure the blade assembly 2 on the excavator bucket 25, as illustrated in FIG. 14. The remaining bucket teeth 29 are designed to fit over the blade backplate 11 in the blade assembly 2, as further illustrated in FIG. 14. In a preferred aspect of this embodiment of the invention the chain tightener 13 illustrated in FIG. 15 can be utilized as heretofore described with respect to FIGS. 2 and 8 of the drawings, to further secure the blade assembly 2 to the excavator bucket 25. The blade assembly 2 can then be utilized to cut a stump 37 (FIG. 1) in the same manner as heretofore illustrated and described, by operation of the excavator bucket arm 24 and the excavator bucket 25.

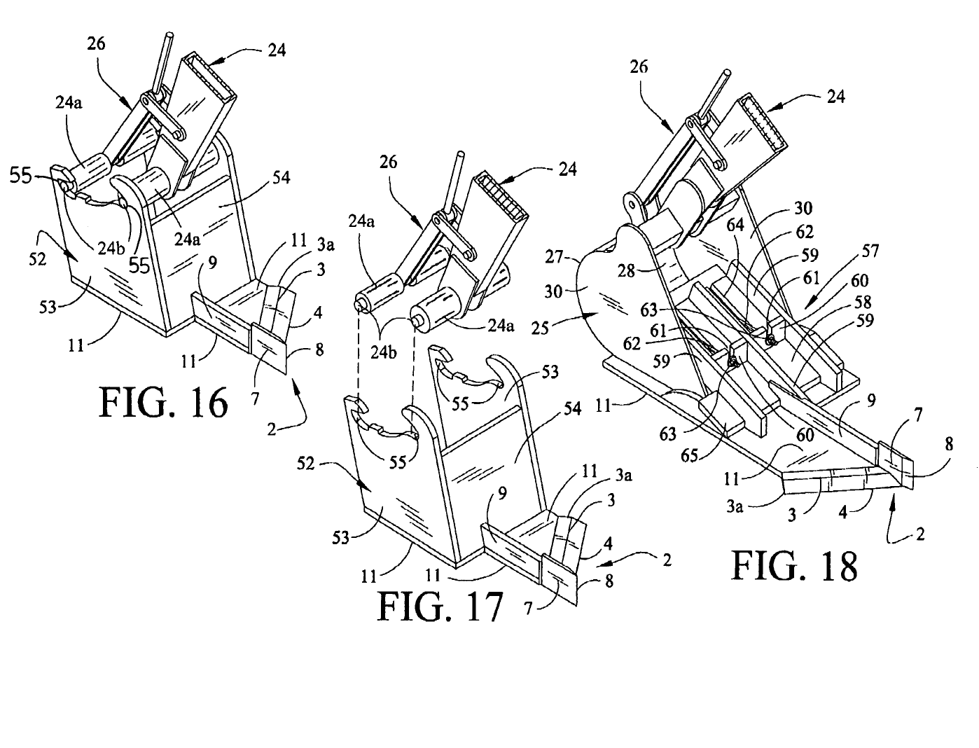

Referring to FIGS. 16 and 17 of the drawings, in yet another embodiment of the invention the blade assembly 2 is attached to a blade assembly housing 52 characterized by housing sides 53, a housing front plate 54 and matching, spaced-apart pin-engaging slots 55 located in the top of the housing sides 53 (FIG. 17). In a typical design the blade backplate 11 of the blade assembly 2 serves as the bottom of the blade assembly housing 52 and the stinger blade mount 9 extends through a slot or opening in the housing front plate 54. Alternatively, the stinger blade mount 9 may be welded to the housing front plate 54, and in either case, serves to stabilize the blade assembly 2, which is configured substantially as illustrated in FIGS. 1-15, on the blade assembly housing 52. As further illustrated in FIGS. 16 and 17 the pin-engaging slots 55 are designed to receive corresponding pin ends 24b, extending from the respective arm mount pins 24a that are mounted on the excavator bucket arm 24 and bucket operating linkage 26. This engagement is illustrated in FIG. 16 and facilitates operation of the blade assembly housing 52 and blade assembly 2 in the manner heretofore described with respect to the other embodiments of the invention, by manipulation and operation of the excavator bucket arm 24.

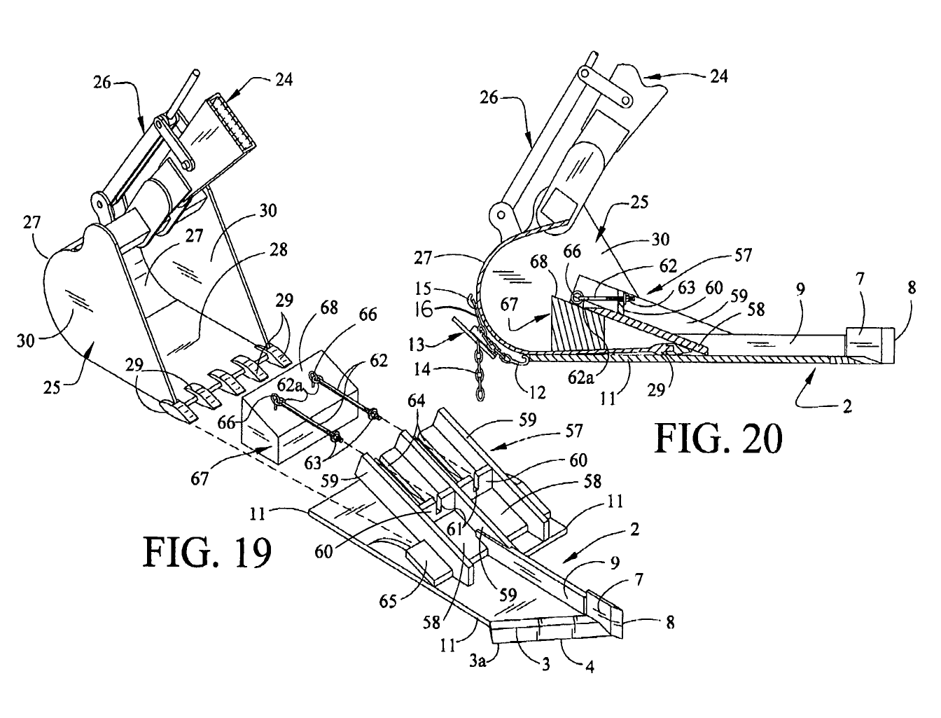

Referring now to FIGS. 18-20 of the drawings, in yet another embodiment of the invention a bucket-engaging pad is generally illustrated by reference numeral 57 and includes a pad plate 58, which is inclined with respect to the blade backplate 11 of the blade assembly 2 and extends to welded attachment to the blade backplate 11 at the forward end of the pad plate 58. The rear portion of the pad plate 58 rests on the pad face 68 of a pad wedge 67, which is welded or otherwise attached to the bucket bottom 28 of the excavator bucket 25, as illustrated in FIG. 20. Face plates 59 are upward-standing from the pad plate 58 in spaced-apart relationship and are typically secured by welding to the pad plate 58 and to the pad braces 65. As further illustrated in FIG. 20 a pair of bolt mounts 66 are spaced-apart on the pad wedge 67 and each receive the bolt eye 62a of a pair of pad mount bolts 62, such that the pad mount bolts 62 are configured to articulate on the respective bolt mounts 66 with respect to the pad plate 58. A pair of pad mount plates 60 are welded or otherwise attached to the pad plate 58 between the face plates 59 and include pad slots 61, as further illustrated in FIGS. 18 and 19, for receiving the respective pad mount bolts 62, having corresponding mount bolt nuts 63 threaded on the ends thereof. Accordingly, since the front edge of the pad plate 58 is welded or otherwise attached to the blade backplate 11 of the blade assembly 2, tightening of the respective mount bolt nuts 63 on the corresponding pad mount bolts 62 secures the blade assembly 2 on the fixed pad wedge 67 in the position illustrated in FIGS. 18 and 20. The bucket-engaging pad 57 and blade assembly 2 can then be utilized to cut a stump 37 as illustrated in FIG. 1 of the drawings, by manipulation of the excavator bucket arm 24 and excavator bucket 25, according to the procedure heretofore described with respect to other embodiments of the invention.

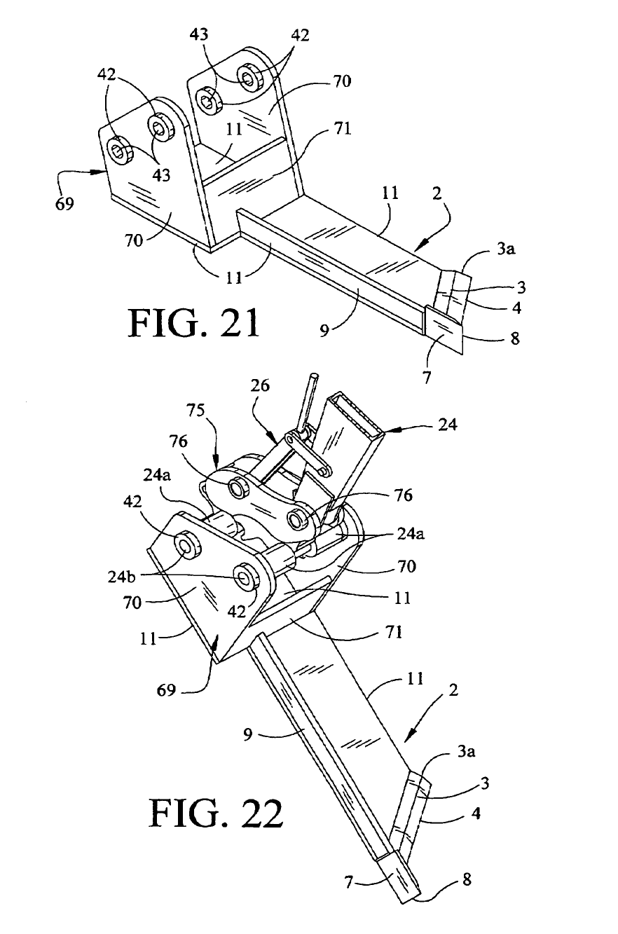

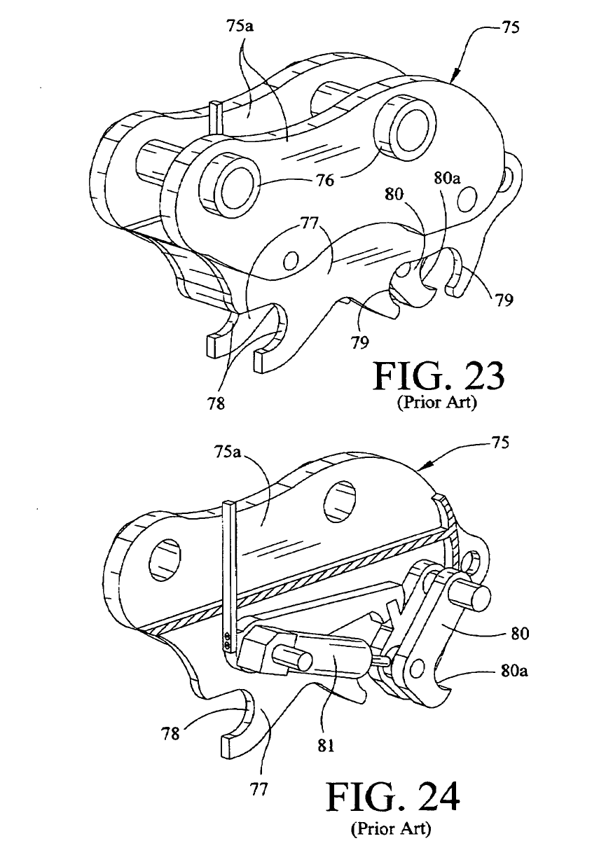

Referring now to FIGS. 21-24 of the drawings, in yet another embodiment of the invention a parallel mount plate housing 69 is illustrated and includes a pair of blade assembly mount plates 70 extending upwardly, typically in parallel relationship with respect to each other and connected by a mount plate brace 71. Side panel bosses 42 and boss openings 43 are provided in spaced-apart relationship with respect to each other on each of the blade assembly mount plates 70 and align with each other, respectively, for receiving the respective pin ends 24b of arm mount pins 24a, as illustrated in FIG. 22. In a preferred design the stinger blade mount 9 of the blade assembly 2 either extends through a slot provided in the mount plate brace 71 or it may be welded to the mount plate brace 71, to brace the blade assembly 2 in functional position on the parallel mount plate housing 69. In a preferred design the blade assembly 2 is slightly elongated, such that the stinger blade mount 9 is longer than the blade assembly 2 components illustrated in prior embodiments of the invention. In this embodiment of the invention the excavator bucket arm 24 and bucket operating linkage 26 are each fitted with a common pin coupler 75, typically of conventional design and characterized by parallel coupler spacer plates 75a, each having spaced-apart coupler bosses 76, as illustrated in FIG. 23. A pair of pin-engaging plates 77 extend downwardly from the coupler spacer plates 75a and each have a front pin-engaging slot 78 for receiving the forward one of the arm mount pins 24a and a rear pin-engaging slot 79 for receiving the rear arm mount pin 24a. An engaging trigger 80 is provided opposite the rear pin-engaging slot 79 and is characterized by a curved surface 80a, that engages the rear arm mount pin 24a and forces it against the rear pin-engaging slot 79 in the pin-engaging plate 77. A trigger cylinder 81 controls the pivoting operation of the engaging trigger 80, to selectively force the engaging trigger 80 forwardly when the pin coupler 75 is positioned as illustrated in FIG. 22, and lock the pin coupler 75 on the parallel arm mount pins 24a, as further illustrated in FIG. 22.

It will be appreciated from a consideration of the above that in each of the embodiments of the excavator stump-shearing device illustrated in FIGS. 1-22 of the drawings, the blade assembly 2 can be quickly and easily attached to a conventional excavator bucket 25 or directly to the excavator bucket arm 24 in place of the excavator bucket 25, in the latter case, using the arm mount pins 24 and in one case, the arm mount pins 24 and front linkage pins 48. The device can then be quickly and efficiently used for splitting, shearing and cutting a stump 37 to ground level or below, by manipulation of the excavator bucket 25 or the excavator bucket arm 24 without the excavator bucket 25, using the bucket operating linkage 26 and conventional excavator controls (not illustrated). Furthermore, a stump 37 of substantially any size can be cut or sheared in successive increments of selected size by simply using the wedge or stinger blade 7 and the shearing blade 3 in concert in the various illustrated embodiments, to isolate a selected segment of the stump 37 to be cut as illustrated in FIGS. 1 and 2 of the drawings and slicing the isolated segments from the stump 37 as wood chips 39. It will be further recognized that the size of the isolated segments or wood chips 39 to be cut from a stump 37 is dependent upon the wood type and size of the stump to be removed and the power of the excavator which mounts the excavator bucket arm 24 and the bucket operating linkage 26. Furthermore, the process of cutting the stump 37 is optimized by maintaining the shearing blade edge 4 of the shearing blade 3 and the stinger blade edge 8 of the wedge or stinger blade 7 in sharp operating condition. Moreover, the combination of the wedge or stinger blade 7 and the tapered shearing blade 3 in each blade assembly 2 can be utilized to remove the wood chips 39 from the cut surface 38 of the stump 37 by sidewise movement of the excavator bucket 25 or the blade mount box 40 while operating the excavator bucket arm 24 in the manner known to those skilled in the art. Another advantage realized in each of the embodiments of the invention described above in the excavator stump shearing device 1, is the design of the extended blade end 3a of the shearing blade 3 as described above, and the safety factor involved, since wood chips 39 are not thrown from the stump 37 at the cut surface 38 with sufficient velocity to present a safety hazard.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A stump shearing device for mounting on an excavator bucket and cutting a stump,: comprising a blade assembly carried by the excavator bucket, said blade assembly comprising a blade backplate engaging the excavator bucket; a shearing blade provided on said blade backplate and a wedge blade provided on said blade backplate adjacent to said shearing blade, wherein said wedge blade and said shearing blade cut the stump responsive to operation of the excavator bucket.

2. The stump shearing device of claim 1 wherein said shearing blade is tapered from a maximum length at said wedge blade to a minimum length spaced-apart from said wedge blade.

3. The stump shearing device of claim 1 wherein the excavator bucket includes a bucket thumb and comprising a blade mount drum carried by said blade backplate for releasably receiving the bucket thumb and removably mounting said blade assembly on the excavator bucket.

4. The stump shearing device of claim 3 wherein said shearing blade is tapered from a maximum length at said wedge blade to a minimum length spaced-apart from said wedge blade.

5. The stump shearing device of claim 3 comprising at least two blade mounts provided on said blade backplate and said blade mount drum in spaced-apart relationship with respect to each other for receiving the excavator bucket and stabilizing said blade assembly on the excavator bucket.

6. The stump shearing device of claim 5 wherein said shearing blade is tapered from a maximum length at said wedge blade to a minimum length spaced-apart from said wedge blade.

7. The stump shearing device of claim 5 wherein the excavator bucket has teeth and wherein at least one of the teeth of the excavator bucket projects between said blade mounts.

8. The stump shearing device of claim 7 wherein said shearing blade is tapered from a maximum length at said wedge blade to a minimum length spaced-apart from said wedge blade.

9. The stump shearing device of claim 1 comprising a connecting mechanism carried by said blade backplate, said connecting mechanism connected to the excavator bucket for securing said blade assembly on the excavator bucket.

10. The stump shearing device of claim 9 wherein said shearing blade is tapered from a maximum length at said wedge blade to a minimum length spaced-apart from said wedge blade.

11. The stump shearing device of claim 9 wherein the excavator bucket includes a bucket thumb and comprising a blade mount drum carried by said blade backplate for releasably receiving the bucket thumb and removably mounting said blade assembly on the excavator bucket.

12. The stump shearing device of claim 11 comprising at least two blade mounts provided on said blade backplate and said blade mount drum in spaced-apart relationship with respect to each other for receiving the excavator bucket and stabilizing said blade assembly on the excavator bucket.

13. The stump shearing device of claim 12 wherein said shearing blade is tapered from a maximum length at said wedge blade to a minimum length spaced-apart from said wedge blade.

14. The stump shearing device of claim 13 wherein the excavator bucket has teeth and wherein at least one of the teeth of the excavator bucket projects between said blade mounts.

15. The stump shearing device of claim 1 comprising at least two mount blocks provided on said blade backplate for receiving the excavator bucket and stabilizing said blade assembly on the excavator bucket.

16. The stump shearing device of claim 15 comprising a connecting mechanism carried by said blade backplate, said connecting mechanism connected to the excavator bucket for securing said blade assembly on the excavator bucket.

17. The stump shearing device of claim 15 wherein said shearing blade is tapered from a maximum length at said wedge blade to a minimum length spaced-apart from said wedge blade.

18. The stump shearing device of claim 15 comprising a connecting mechanism carried by said blade backplate, said connecting mechanism connected to the excavator bucket for securing said blade assembly on the excavator bucket and wherein said shearing blade is tapered from a maximum length at said wedge blade to a minimum length spaced-apart from said wedge blade.

19. The stump shearing device of claim 15 comprising block bolts threaded through said mount blocks and spacer blocks disposed on the excavator bucket beneath said mount blocks for receiving said block bolts and stabilizing said blade assembly on the excavator bucket responsive to tightening of said block bolts against said spacer blocks.

20. The stump shearing device of claim 19 comprising a connecting mechanism carried by said blade backplate, said connecting mechanism connected to the excavator bucket for securing said blade assembly on the excavator bucket.

21. The stump shearing device of claim 19 wherein said shearing blade is tapered from a maximum length at said wedge blade to a minimum length spaced-apart from said wedge blade.

22. The stump shearing device of claim 19 comprising a connecting mechanism carried by said blade backplate, said connecting mechanism connected to the excavator bucket for securing said blade assembly on the excavator bucket and wherein said shearing blade is tapered from a maximum length at said wedge blade to a minimum length spaced-apart from said wedge blade.

23. A stump shearing device for mounting on the excavator bucket of an excavator and shearing a stump, comprising a blade backplate disposed for insertion against the excavator bucket; a shearing blade carried by said blade backplate; a wedge blade carried by said blade backplate adjacent to said shearing blade; and at least two mount blocks provided on said blade backplate for engaging the excavator bucket and stabilizing said blade assembly on the excavator bucket responsive to said shearing of the stump by operation of the excavator and the excavator bucket.

24. The stump shearing device of claim 23 wherein the excavator bucket has teeth and wherein the teeth of the excavator bucket project between said mount blocks.

25. The stump shearing device of claim 24 comprising a connecting mechanism carried by said blade backplate, said connecting mechanism connected to the excavator bucket for securing said blade backplate on the excavator bucket.

26. The stump shearing device of claim 25 wherein said shearing blade is tapered.

27. The stump shearing device of claim 26 comprising block bolts threaded through said mount blocks and spacer blocks disposed on the excavator bucket beneath said mount blocks for receiving said block bolts and stabilizing said blade assembly on the excavator bucket responsive to tightening of said block bolts against said spacer blocks.

28. A stump shearing device for mounting on an excavator bucket arm and operating linkage and cutting stumps responsive to operation of the excavator bucket arm, said stump shearing device comprising a blade assembly apparatus characterized by a blade mount box for mounting on the bucket arm and operating linkage, and a blade assembly characterized by a shearing blade carried by said blade mount box for shearing the stump and a wedge blade carried by said blade mount box adjacent to said shearing blade for splitting the stump.

29. The stump shearing device of claim 28 comprising a blade backplate extending from said blade mount box and wherein said shearing blade is tapered from a maximum length on said blade backplate at said wedge blade to a minimum length spaced-apart from said wedge blade.

30. The stump shearing device of claim 28 comprising box openings provided on said blade mount box and pins extending through said box openings, the bucket arm and the operating linkage for removably securing said blade mount box and said blade assembly on the bucket arm and operating linkage.

31. The stump shearing device of claim 30 wherein said shearing blade is oriented in transverse relationship with respect to said wedge blade and said shearing blade is tapered from a maximum length at said wedge blade to a minimum length spaced-apart from said wedge blade.

32. The stump shearing device of claim 28 comprising a blade backplate extending from said blade mount box and wherein said shearing blade and said wedge blade are fixed to said blade backplate.

33. The stump shearing device of claim 32 wherein said shearing blade is oriented in transverse relationship with respect to said wedge blade and said shearing blade is tapered from a maximum length at said wedge blade to a minimum length spaced-apart from said wedge blade.

34. The stump shearing device of claim 32 comprising box openings provided on said blade mount box and pins extending through said box openings, the bucket arm and the operating linkage for removably securing said blade mount box and said blade assembly on the bucket arm and operating linkage.

35. The stump shearing device of claim 32 wherein said shearing blade projects beyond the plane of said blade box, said shearing blade is oriented in transverse relationship with respect to said wedge blade and said shearing blade is tapered from a maximum length at said wedge blade to a minimum length spaced-apart from said wedge blade, and comprising panel bosses provided on said blade mount box and pins extending through said panel bosses, the bucket arm and the operating linkage for removably securing said blade mount box and said blade assembly on the bucket arm and operating linkage.

36. A stump shearing device for mounting on an excavator bucket arm and operating linkage, and shearing stumps responsive to operation of the excavator bucket arm, said stump shearing device comprising a blade mount box for mounting on the bucket arm, a shearing blade carried by said blade mount box for shearing the stump and a wedge blade carried by said blade mount box substantially transverse to said shearing blade for splitting the stump.

37. The stump shearing device of claim 36 wherein said shearing blade is tapered from a maximum length at said wedge blade to a minimum length spaced-apart from said wedge blade.

38. The stump shearing device of claim 36 comprising box openings provided on said blade mount box and pins extending through said box openings, the bucket arm and the operating linkage for removably securing said blade mount box, said shearing blade and said wedge blade on the bucket arm and operating linkage.

39. The stump shearing device of claim 38 comprising a blade backplate extending from said blade mount box and wherein said shearing blade and said wedge blade are fixed to said blade backplate.

40. The stump shearing device of claim 36 wherein said shearing blade projects beyond the plane of said blade mount box.

41. The stump shearing device of claim 39 wherein:
(a) said shearing blade is tapered from a maximum length at said wedge blade to a minimum length spaced-apart from said wedge blade; and
(b) said shearing blade projects beyond the plane of said blade mount box.

42. The stump shearing device of claim 41 comprising panel bosses provided on said blade mount box at said box openings and pins extending through said panel bosses and said box openings, the bucket arm and the operating linkage for removably securing said blade mount box, said shearing blade and said wedge blade on the bucket arm and operating linkage.

43. The stump shearing device of claim 39 wherein the bucket arm and operating linkage are fitted with a pin coupler and the pin coupler removably engages said pins for selectively mounting said blade mount box and said blade assembly on the bucket arm and operating linkage.

44. The stump shearing device of claim 36 comprising oppositely-disposed slots provided in said blade mount box and pins provided on the excavator bucket arm and the operating linkage for removably engaging said slots and selectively mounting said blade mount box, said shearing blade and said wedge blade on the bucket arm and operating linkage.

45. A stump shearing device for mounting on an excavator bucket arm and operating linkage having a pin coupler, said stump shearing device comprising a blade mount; a pair of mount pins provided on said blade mount for receiving the pin coupler; a shearing blade carried by said blade mount; and a wedge blade carried by said blade mount adjacent to said shearing blade, for splitting the stump responsive to operation of the excavator bucket arm.

46. The stump shearing device of claim 45 wherein said shearing blade is tapered from a maximum length at said wedge blade to a minimum length spaced-apart from said wedge blade.

47. The stump shearing device of claim 45 comprising a blade backplate extending from said blade mount box and wherein said shearing blade and said wedge blade are fixed to said blade backplate.

48. The stump shearing device of claim 47 wherein:
(a) said shearing blade is tapered from a maximum length at said wedge blade to a minimum length spaced-apart from said wedge blade; and
(b) said shearing blade projects beyond the plane of said blade mount.

49. A stump shearing device for mounting on an excavator bucket and cutting a stump, comprising a blade assembly characterized by a blade backplate; a shearing blade provided on one end of said blade backplate; a wedge blade provided on said blade backplate adjacent to said shearing blade; a pad plate fixed to said blade backplate, said pad plate disposed in angular relationship with respect to said blade backplate; a pad wedge fixed to the excavator bucket, said pad wedge engaging said pad plate; and at least one plate connecting mechanism carried by said pad wedge, said pad connecting mechanism removably engaging said pad plate, for removably securing said blade assembly and said pad plate on the pad wedge, wherein said wedge blade and said shearing blade cut the stump responsive to operation of the excavator bucket.

50. The stump shearing device of claim 49 wherein said plate connecting mechanism comprises a pair of bolts mounted in articulating relationship on said pad wedge for selective engagement with said pad plate.
